(19) United States
(12) Patent Application Publication
(10) Pub. No.: US 2007/0005969 A1
(43) Pub. Date: Jan. 4, 2007

(54) Anonymous communication system and method

(75) Inventor: Larry W. Fullerton, New Hope, AL (US)

Correspondence Address: JAMES RICHARDS, 58 BONING RD, FAYETTEVILLE, TN, 37334, US

(73) Assignee: ADDnCLICK, Inc., Vacaville, CA (US)

(21) Appl. No.: 11/477,162

(22) Filed: Jun. 28, 2006

Related U.S. Application Data
(60) Provisional application No. 60/696,200, filed on Jul. 2, 2005.

(51) Int. Cl. H04L 9/00

(52) U.S. Cl. 713/168

(57) ABSTRACT

A system for anonymous communication wherein a first party, subscriber, stores private contact address information with a server controlled by a trusted third party. The subscriber is associated with a token in the server database. The subscriber may publish the token with information of interest to a second party. The second party may then contact the server and provide the token. The server then enables communications between the first and second parties without either knowing the necessary contact information to independently make contact. The token may be published in any media and may be used to establish connection with email, voice, voice mail, e-chat rooms, or other communication media. In one embodiment, the third party may establish an account with the first party and may charge the first party for the communication service.

### RELATED APPLICATIONS

This application claims the benefit under 35 USC 119(e) of U.S. Provisional Application 60/696,200 filed Jul. 2, 2005 by Fullerton, which is incorporated herein by reference in its entirety.

### Background

1. Field of the Invention

The present invention pertains generally to the field of communications, more particularly to the field of anonymous communications.

2. Background of the Invention

When conducting business, or in personal affairs, or otherwise, there arise instances or types of situations where two parties may wish to communicate without establishing a permanent contact. The communication is typically to make a first inquiry about a subject to ascertain the potential value of proceeding versus the risk of further contact. For example, a person may wish to inquire about a replacement ink cartridge from an online retailer with attractive prices, but unknown quality. The person may be dubious about a direct inquiry because of the risk of further spam type adds from the retailer or associates. In another example, a person selling online, such as through EBay® or other auctions, may wish to respond to questions without revealing his identity and may wish to allow questioners to communicate without revealing their identities. In a further example, as part of a dating listing or newspaper personal advertisement, a person may wish to communicate initially anonymously and break off at anytime without risk of future harassment or annoyance.

A method presently in use for online auctions involves assigning alternate identities for auction purposes. The identities do not have a traceable relationship to an email that may be used for spam or other harassment. The identities, however, persist from one auction to another and may be the source of persistent responses and harassment. Further, the identities may not be used outside of the auction arena or for other purposes than the auction.

Thus, there is a need for an anonymous communication method and system which can be broadly used over a wide range of subjects and situations and applied to multiple communications media such as email, VOIP, voice phone, print media and others.

### BRIEF DESCRIPTION OF THE INVENTION

Briefly, the present invention comprises a system for anonymous communication wherein a first party, subscriber, stores private contact address information with a server controlled by a trusted third party. The subscriber is associated with a token in the server database. The subscriber may publish the token with information of interest to a second party. The second party may then contact the server and provide the token. The server then enables communications between the first and second parties without either knowing the necessary contact information to independently make contact. The token may be published in any media and may be used to establish connection with email, voice, voice mail, e-chat rooms, videoconferencing, instant messaging (IM), text messaging, or other communication media. In one embodiment, the third party may establish an account with the first party and may charge the first party for the communication service. =p These and further benefits and features of the present invention will now be described in detail with reference to exemplary embodiments in accordance with the invention.

### BRIEF DESCRIPTION OF THE FIGURES

The invention will now be described with reference to the following drawings. In the drawings, like numbers represent identical or similar components. The first digits of a reference number identify the drawing number wherein the reference first appears.

FIG. 1 illustrates an exemplary system block diagram including a server system in accordance with the present invention.

FIG. 2 is an exemplary flow diagram for an anonymous communication process in accordance with the present invention.

FIG. 3 is an exemplary flow diagram for the connection process of FIG. 2 further including usage data updating.

FIG. 4 is an exemplary flow diagram for the process of FIG. 3 showing further potential features.

FIG. 5 is an exemplary flow diagram for a subscriber in accordance with the present invention.

FIG. 6 is an exemplary flow diagram for a caller process in accordance with the present invention.

### DETAILED DESCRIPTION OF THE PREFERRED EMBODIMENTS

The present invention comprises a general method of empowering two parties to freely talk or negotiate using email, videoconferencing, instant messaging (IM), text messaging, phone, Voice Over IP (VOIP) and other protocols, without compromising any personal identification in the process. The approach includes methods for returning calls, voice mail, and permanently terminating any future contact at any point. One embodiment of the invention also includes a business method and describes how the users would be charged for the service.

When two parties desire to explore a possible transaction, whether the transaction is the purchase of a used car or a replacement printer ink cartridge, it is frequently desirable for them to converse freely to determine whether the item offered for sale actually answers a need equal to its asking price and to ascertain whether the other party is likely to be reliable in their dealings. Also, there are typically secondary questions, such as shipping method, special packing, etc. that can be settled quickly with a phone call.

The possibility of undesired follow-on contact creates a psychological barrier to placing the call and is therefore an impediment to commerce. For example, the buyer of an ink cartridge may not wish to receive spam or telephone advertising offering credit cards, hot stock picks, or discount cruise vacations. Also, today there is a well-publicized threat of personal ID theft and this further increases the threshold for making the initial contact necessary to develop a business transaction, resulting in many good opportunities lost that would have otherwise resulted in a successful transaction.

The present invention provides a solution to this dilemma by using a trusted server to confidentially maintain detailed contact information for the two parties and use temporary “tokens” to put buyers and sellers into direct contact. The server acts as an automated operator that connects the two parties using the token. This token is assigned to a seller (or more generally, a first party) when the seller places an item for sale. When the server's call-in number is dialed by a potential buyer (more generally called a second party), and followed by the token, the buyer's call is then routed directly to the seller. A return token may also be assigned to the buyer by the server to allow the seller to return calls to the buyer. Since the server contains the seller's contact information, there is no need for the buyer to learn this information. Further, there is no need for the seller to learn the buyer's contact information. Thus, the two parties may communicate anonymously and may call one another repeatedly without giving further contact information.

Although buyers and sellers may form a large group that may benefit from the present invention, others in other situations may also benefit from the features of the invention. In general, a first party establishes a relationship with a third party and obtains a token. The token may be suggested by the first party, or the third party, but should be unique within the database of the third party. The third party controls a server, which includes the contact database and connection equipment. The first party publishes the token with some interesting information that a second party may wish to inquire about or otherwise respond to. The second party then contacts the server of the third party and provides the token. The server then locates and retrieves the first party contact information from the contact database and sends the response to the first party. The response may be a one-way message or may include an interconnection of the first and second parties for conversation. Buyers and sellers are typically used in the examples given in this disclosure; however, the teachings provided herein may be applied more generally to a first party and a second party.

The system may be very flexible and operate over several media and formats. For example the seller may publish an ad in a newspaper giving the server telephone number and seller's token. The buyer may then contact anonymously as above. Alternatively, the seller may provide a server email address with the token embedded, or may specify that the token be placed in the subject line, depending on server software implementation details.

In a telephone contact embodiment, the server may have a list of multiple phone numbers for the seller that may be dialed sequentially or in parallel to increase the likelihood of contacting the seller. Further, each phone number may have a preferred time period, such as a work number or home number. The seller may set up a PIN (Personal Identification Number) number to be keyed in for positive identification upon answering the phone. The PIN may be useful to distinguish between the actual seller and an answering machine or relative or secretary, who may inadvertently give too much contact information or otherwise may not be qualified to answer questions. In the absence of an answer by the seller, a voice mail message may be left by the buyer with a return token, if desired, so that the seller may return the call. The server would automatically explain the system and inquire if the buyer wished to be called back, and if so, does the buyer wish to remain anonymous. The system may then set up a temporary call back token or may reference the call back to the voice mail message. In one embodiment, the call back token may be the original token with the caller number appended to the end. The call back token may only be valid when used from the seller's own telephone number.

In one embodiment, the seller may block future calls from a specific responder. From time to time a seller may encounter a prospective buyer that is unsuitable for some reason. For example, the supposed buyer may be actually selling a product of his own and has no real interest in the seller's product. The system may then be set up to block calls from this responder if some form of ID is available. For example, the responder may have caller ID enabled. The seller will not have direct knowledge of the caller ID, but the seller may, after receiving such unsuitable call, call the server and request blocking of the caller of the immediately preceding call, or the call at a given specified time, or caller associated with voice mail number N, or other identification. The server may then relate the seller's reference to a call with a caller ID known to the server. For email, a blocked list may be similarly developed and optionally, spam blocker software may be utilized.

The token may be any symbol or set of symbols suitable for the medium. For a telephone entry system, a string of numbers may be preferred. Alternatively, the alpha characters may be used to spell an easily remembered word or phrase. For a voice system, numbers, letters, words or phrases may be used. A voice recognition system may be interfaced to the server to utilize voice input. For email, any valid email character or string of characters may be used. For chat rooms an icon may be used.

The token may be a symbol already in use. For example, a seller may utilize the present invention to communicate with prospective bidders using an online auction forum such as EBAY®, in which case, the item number may be used as the token. Using the item number as the token simplifies the transaction process by reducing the number of symbols or numbers that have to be dealt with. The auction description would indicate that communication may be via a third party anonymous system at phone number nnn-nnnnn and to use the item number as the token when requested by the third party system. A prospective bidder, then dials the third party server, enters the item number and is connected to the seller.

Exemplary tokens are provided as follows. The tokens may be entered in the phone by pressing touch-tone keys or by speaking the letters or pronouncing the phrase. In a computer, keyboard entry may be used:

12345
3569375
afctyr
Tractor man
antique desk 231
the quick brown fox jumps over the lazy dog
A$B@&*234

In addition, graphical symbols may be used if the entry medium permits.

In another embodiment of the invention, the medium of exchange may be text edit fields in a web site accessible to both parties.

In a further embodiment, text may be converted to voice and voice to text using voice synthesis and voice recognition techniques. For example, a voice mail message from the second party may be converted to text and sent as a text message email, instant message, text file or other text message to the first party. Alternatively an email may be read over a voice line using text to voice synthesis. Thus message format conversions may be made at the convenience of the parties.

In another embodiment of the invention, the third party may provide general answering service features, such as providing a recorded message, or a menu of recorded messages, or a live operator. The live operator may take orders or handle other complex interfaces with the caller.

In another embodiment of the invention, the seller may provide multiple tokens in the same advertisement. Each token associated with a different type of response, perhaps for different products in the same ad, or for different information, such as buy vs. request information packet, or vote for a preference. The different tokens may be keyed to different responses by the third party, such as voice mail, recorded message, direct contact, contacting different individuals, or other features appropriate for a given situation.

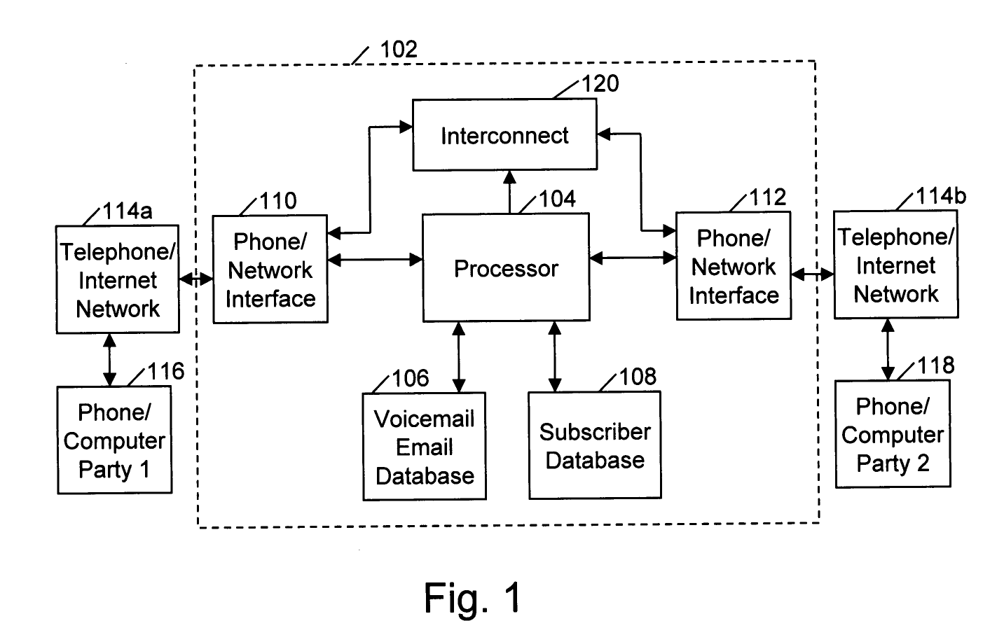

The present invention will now be described with reference to the drawings. FIG. 1 illustrates an exemplary system block diagram including a server in accordance with the present invention. Referring to FIG. 1, a server system 102 is connected through communications media 114a and 114b to a first party 116 and a second party 118. The first and/or second party's equipment 116 and 118 may be a voice phone, cell phone, computer or other communications terminal device. The terminal device is connected to the server through an appropriate network 114a and 114b capable of switching to a number of parties. The network 114a and 114b preferably includes a telephone network for voice telephone contact and/or includes the Internet for VOIP and email contact.

The server system 102 includes network interface devices 110, 112, processor 104, voicemail/email memory 106, subscriber database 108, and interconnect device 120 or function. The processor 104 may be a single processor or may be several processors. The several processors may be spread over several buildings or even in different countries. Likewise the voicemail/email databases 106 may be handled by a single processor 104 or may be distributed over several processors 104 or equipments. The subscriber database 108 includes the contact information for each subscriber and any account attributes together with a list of tokens and response characteristics for each token. The subscriber database 108 may also be distributed as needed for a given implementation. The telephone/network interface 110, 112 may include a dialer to dial the subscriber or caller (call back), may include a caller ID decoder, may include voice digitizing for digital recording of voice mail, or may include voice recognition for receiving voice commands and voice synthesis for giving voice information. The telephone network interface 110, 112 may include a digital modem or interface as necessary for the processor interface. Any number of telephone lines or equivalent lines and associated interface devices may be connected to the server system 120.

The interconnect device and/or function 120 provides direct two-way conversation between the first party and second party. The interconnect device 120 may be a device installed with or in a server processor 104 or may be a separate function controlled by the processor 104. Alternatively, the interconnection function 120 may be implemented using telephone company services and equipment controlled by the processor 104. Alternatively, the interconnection function 120 may include a digital processing path within one or more server processors 104. For some embodiments, the interconnect function 120 is one way. One way interconnect may be performed for email or voice mail service, which may be stored on the server for later retrieval.

The server system 102 may be housed in a single rack or equipment room or may be distributed among several rooms, or buildings, possibly in different states or countries as appropriate for the customer base.

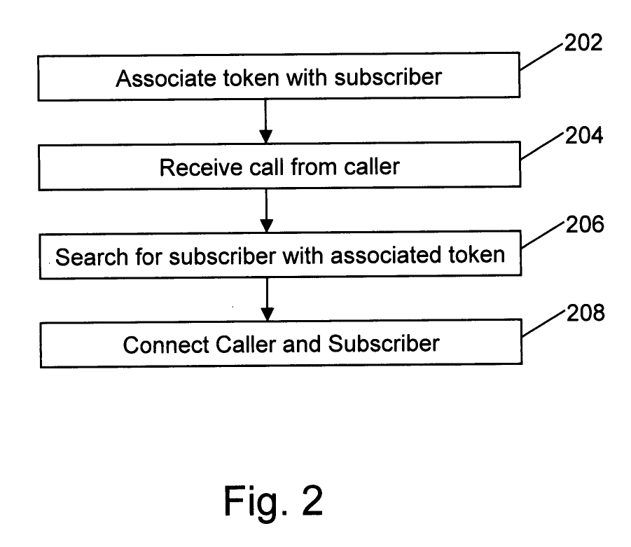

FIG. 2 is an exemplary flow diagram for an anonymous communication process in accordance with the present invention. Referring to FIG. 2, a token is associated with a first party, subscriber 202. The subscriber may first establish an account on a server and as part of the initialization of the account, may establish one or more tokens to be used by the subscriber. The account will also have the subscriber's contact information. The contact information may also be called the contact address and may include phone numbers, email addresses or other contact information. Alternatively, the subscriber may already have an account and may update the account to establish one or more new tokens or discontinue tokens as necessary. Thus, the server may associate a token with a particular subscriber and with the subscriber's contact information. The token should be unambiguously associated with a particular subscriber. Duplicate tokens with different subscribers would not typically be used unless additional information is available to differentiate the subscribers. The subscribers and associated tokens may be stored in a subscriber database, depending on the business purpose associated with the server. In one embodiment, the subscriber data may be indexed by token for quick access. Alternatively other data structures may be used as are known by those skilled in the art of database construction and searching.

Once the token is established, the server waits for a call from a caller. Upon receiving the call 204, the server searches for the subscriber associated with the token in the subscriber database 206 in order to find the associated contact information. Upon finding the contact information, the server connects the caller to the subscriber 208 in accordance with connection policies associated with the subscriber and token. The connection may be direct voice telephone connection, or may be voice mail or email or other connection type as discussed above.

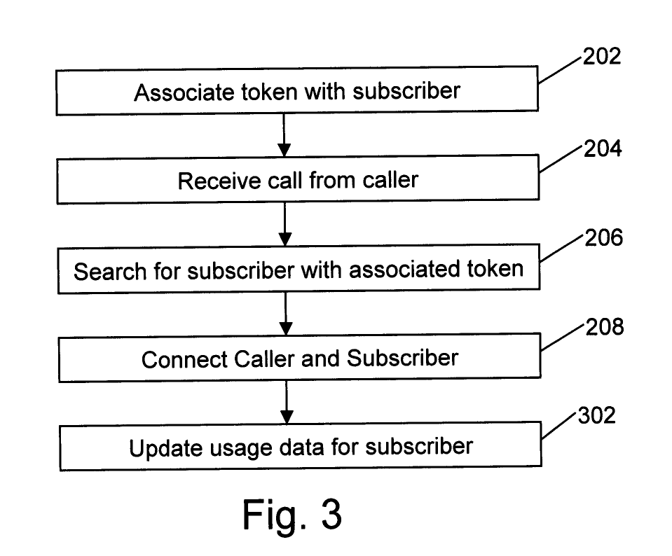

FIG. 3 is an exemplary flow diagram for the connection process of FIG. 2 further including usage data updating. Referring to FIG. 3, the steps are similar to the steps of FIG. 2 with the addition of step 302 wherein usage for the subscriber is updated. Usage data may include a number of usage metrics such as the number of calls received, number of tokens active, number of minutes of contact with callers, number of emails or bytes of emails exchanged or other statistics on system usage. In one embodiment, the usage data may then be used to charge the subscriber for the service.

Alternatively, the service may be provided as part of a package including other services or products such that no direct line item billing is attributed to the service, although income may be derived from the total package. In some cases, it may be appropriate to bill the caller for the service.

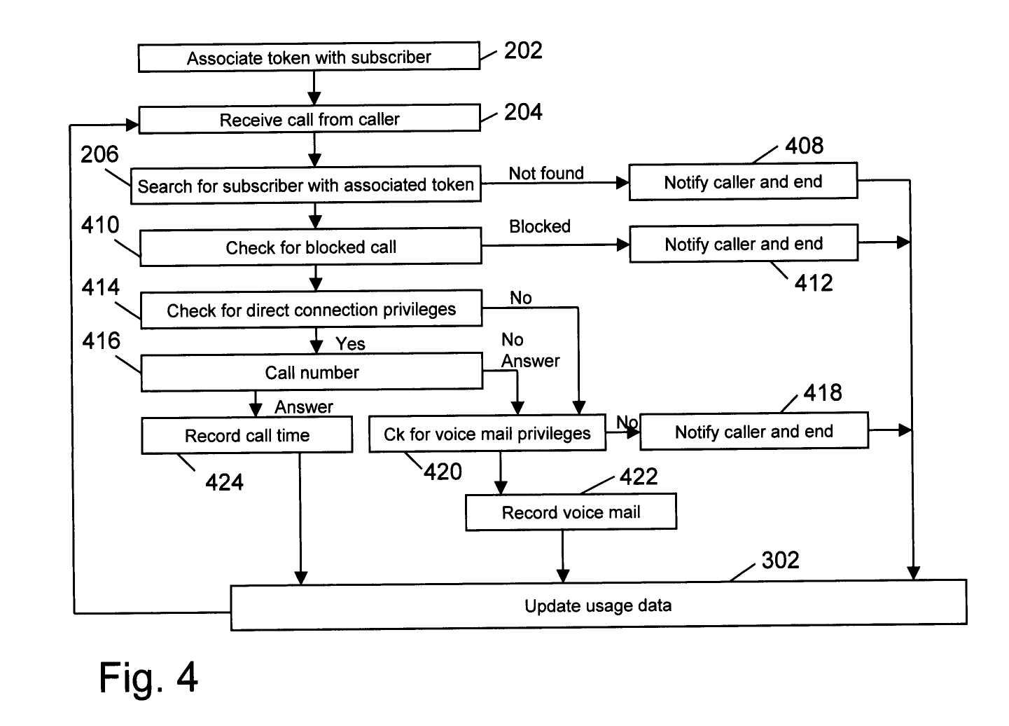

FIG. 4 is an exemplary flow diagram for the process of FIG. 3 showing further potential features. Referring to FIG. 4, the token is associated with the subscriber 202 as above. When a call is received by the server from the caller 204 and the caller provides the token, the subscriber database is searched for the subscriber associated with the token 206. If no subscriber is found for the token given, the caller is notified and the call is terminated 408. System usage data may then be updated 302, but no subscriber can be identified.

If a subscriber is found, subscriber account properties are referenced to find actions to be taken. Actions may be generally specified or may be particular for each token. Actions may include checking for a blocked call 410 as shown in FIG. 4. If caller information is available, such as for example caller ID, a blocked call list may be compared with caller information. If the caller is blocked, the caller may be notified that connection is not available, and the call terminated. Usage data is then updated 302 for the subscriber.

If the call is not blocked, the account is checked for direct connection privileges 414 for the token, if not, voice mail privileges are checked 420, if not the caller is notified and call is terminated 418. If voice mail privileges are available the message is recorded 422 and usage data is recorded 302 for the subscriber.

If direct connection is permitted, the subscriber is called 416. The subscriber may have a single line, or alternatively, the subscriber may be called on several phone or cell phone lines simultaneously. When the subscriber answers the phone 424, the server will identify itself, then the subscriber may enter a PIN (personal identification number), which may be one or more buttons on the keypad, and the server then connects the subscriber to the caller. Other lines not used are then terminated. The PIN may be useful to distinguish actual subscriber contact from answering machines, relatives, or secretaries that may not be authorized.

If the subscriber is dialed but does not answer or provide the PIN, the account will be checked for voice mail privileges 420, and if so, the caller will be switched to voice mail 422.

Before and/or after the subscriber is dialed, or voice mail is recorded, the system may prompt the caller to provide callback information. Call back information may be given a callback token and a temporary account established for callback only. Alternatively, the subscriber may reference the caller by the time of the call.

Once the call is terminated, call usage data may be recorded 302 for the subscriber.

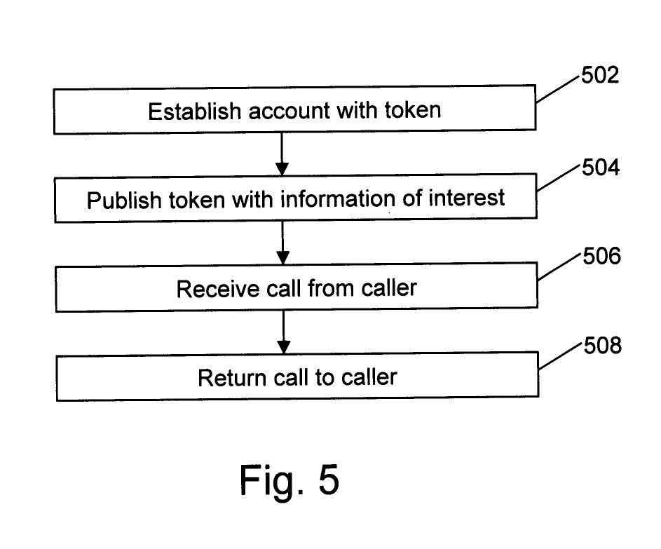

FIG. 5 is an exemplary flow diagram for a subscriber process in accordance with the present invention. Referring to FIG. 5, the subscriber establishes an account with the server 502 and establishes an associated token. The subscriber then publishes the token associated with information of interest 504, such as an advertisement for an item, an online auction item, a personal ad or other information. The publication media may be any media, for example, newspapers, magazines, flyers, radio, television, web page, email, online auction, direct mail, public address announcement, or any other media. The subscriber then receives a call from the caller 506, the call being established by the server based on the token provided by the caller

Once the call is terminated, the subscriber may further initiate an anonymous callback to the caller 508, if the caller established callback information with the server. In one embodiment, the caller may establish a token with the server for callback.

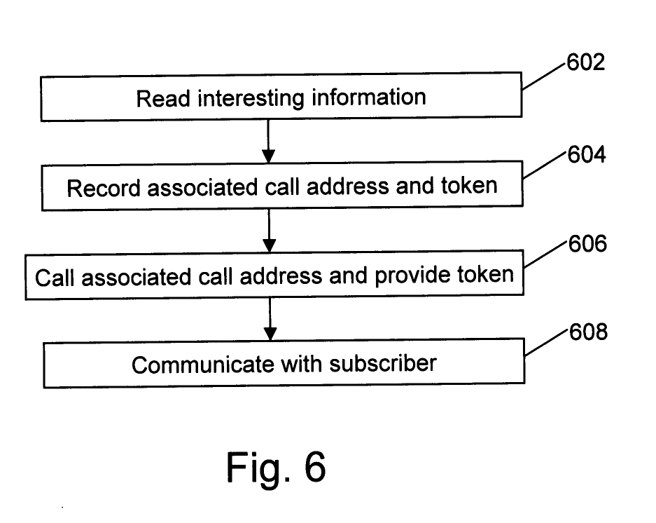

FIG. 6 is an exemplary flow diagram for a caller process in accordance with the present invention. Referring to FIG. 6, the caller will observe the interesting information 602 and note the associated contact information for the server together with the token 604. The caller will then call the server and provide the token 606. The caller will typically be given a brief explanation of the system and be offered an opportunity to provide callback information anonymously. If the subscriber is successfully contacted, the caller will then be connected to the subscriber for conversation 608. Once the conversation is completed, the caller may be offered further options, such as anonymous callback. If the subscriber cannot be contacted, the caller may be offered voice mail and may again be offered anonymous callback.

TABLE 1
Subscriber Account Properties

Subscriber Name
Subscriber Billing Information
Phone Number List
Calling Protocol
Token List
Blocked Caller List

Table 1 lists a number of account properties for each subscriber in the subscriber database. Referring to Table 1, the subscriber name may be optional, consistent with the need for billing. Subscriber billing information may include a billing address, credit card info, email address etc. In one embodiment, the subscriber may pay in advance using PayPal® or other method of payment having no need for a name.

At least one phone number or email address or other contact address is necessary. More than one phone number may be provided. The calling protocol associates with each phone number the valid time interval for that phone number, such as a work phone 8:00 AM to 5:00 PM, and a priority for that phone number for sequential calling. The calling protocol includes the PIN and whether a PIN is required for each phone number.

The token list is a list of each token and associated phone numbers for each token. In one embodiment, the calling protocol may be specified separately for each token.

### CONCLUSION

While several examples are given using telephone calling as the communication media, it will be appreciated that e-chat, or other media may be used as well, and that where two-way conversation is suggested, one-way communication such as voice mail or email may readily be adapted in light of the teachings herein.

Thus, herein described is a system and related method for anonymous communications which can be broadly used over a wide range of subjects and situations and applied to multiple communications media such as email, VOIP, voice phone, print media and others.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. System for permitting anonymous communications between a first party and a second party comprising:
a server system, said server system comprising a private database of addresses searchable by tokens, said database containing a first address of a first party associated with a first token;
a connection means for interconnecting communication paths;
a first communication path between said first party and said connection means, said first communication path referenced by said first address; and
a second communication path between said second party and said connection means;
wherein said connection means connects said first communication path and second communication path after said server system is contacted by said second party and said second party provides said first token to said server system.

4. The system of claim 1, wherein the connection means comprises a software function.

5. The system of claim 4, wherein the communications is by email, voice mail, instant messaging, text messaging, or videoconferencing.

6. The system of claim 1, wherein the communications is by voice conversation.

7. The system of claim 6, wherein the communications is by voice over internet protocol.

8. The system of claim 1, further including stored address information for connection to said second party, wherein said system is further capable of callback connection to said second party using said stored address information for connection to said second party.

9. The system of claim 1, wherein said token is derived from an auction number.

10. The system of claim 1, further including an account for said first party, said account associated with said server system.

11. The system of claim 10, wherein said first party is charged fees in accordance with a usage metric.

12. The system of claim 11, wherein said usage metric comprises at least one from the group consisting of number of messages received, total message time, and bytes of data transferred.

13. A method for providing anonymous communications between a first party and a second party comprising:
receiving and storing contact information for contacting said first party;
associating said contact information with a token;
receiving a message comprising said token from said second party;
retrieving said contact information based on said token;
receiving a communication from said second party for said first party; and
providing said communication to said first party based on said contact information.

14. The method of claim 13, wherein the communication comprises at least one from the group consisting of email, voice mail, and direct conversation.

15. The method of claim 13, further including the step of:
publishing said token in a publication, wherein receiving said token comprises receiving said token from said publication.

16. The method of claim 15, wherein the publication is at least one from the group consisting of a newspaper, an online auction, a magazine, and a web page.

17. A method for anonymous communications between a first party and a second party comprising:
providing a server to
establish a contact address for a first party,
associate a token with said contact address,
establish contact with a second party,
receive a message comprising said token from said second party,
contact said first party based on said token and said contact address, and
establish contact between said first party and said second party; and
charging a fee to said first party for said establishing contact with said second party.

18. The method of claim 17, wherein said providing a server comprises contracting with an entity to operate said server.

19. A method for anonymous communications between a first party and a second party comprising:
storing a first party contact address on a server controlled by a third party, said server having a server contact address;
associating said first party contact address with a token;
publishing said token and said server contact address;
contacting said server by said second party using said server contact address;
providing said token to said server by said second party;
locating said first party contact address based on said token;
contacting said first party by said server based on said first party contact information;
receiving a communication from said second party for said first party; and
providing said communication from said second party to said first party.

20. A method for anonymous communications between a first party and a second party comprising:
establishing an account on a server, said server associated with a third party;
establishing a token associated with said account;
publishing said token associated with interesting information; and
communicating with said second party;
said server having established communications between said first party and said second party based on said token being provided by said second party.
